(19) United States
(12) Patent Application Publication
(10) Pub. No.: US 2008/0311958 A1
(43) Pub. Date: Dec. 18, 2008

(54) TWIST ELECTRONIC DEVICE AND METHODS THEREFOR

(75) Inventors: GARY J. OSWALD, ELK GROVE VILLAGE, IL (US); WILLIAM S. PIERCE, ALGONQUIN, IL (US); WILLIAM J. RYAN, LIBERTYVILLE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/763,495

(22) Filed: Jun. 15, 2007

(51) Int. Cl. H04M 1/00; G06F 1/30; G09G 5/00

(52) U.S. Cl. 455/566; 345/1.1; 345/173

(57) ABSTRACT

Disclosed is an electronic device including a first and second housing. Each housing may include at least one display that may be on a front face or a rear face of the housing. A hinge may couple the first housing and the second housing and may be configured to allow the first housing and the second housing to change their orientation relative to one another with a twist motion around an axis defined by the hinge. With a twist motion, the housings can form a closed configuration and at least one open configuration. Multiple display screen and communication modes may be enabled based on a relative orientation of the housings. In this way, a “twist phone” form factor may provide the shape and function to add and/or improve features that may be desirable to a user.

### FIELD

The present disclosure relates to electronic devices and methods of operation, the electronic devices comprising two or more displays, and further comprising two or more housing portions rotationally coupled by a hinge, the hinge allowing various rotational configurations of the housings to form various angles therebetween, and having various display screen modes respective to the orientation of the housings.

### BACKGROUND

Manufacturers of electronic devices such as, but not limited to, mobile communication devices, continue to improve device form factors and/or develop new form factors for a variety of reasons. For example, new form factors or form factor improvements may be needed in light of increasing and improving functionality of such devices. While there is a trend toward the inclusion of more features and improvements for current features, there is also a trend toward smaller mobile communication devices.

Therefore, new form factors may be created to add and/or improve features while maintaining or decreasing the size of a device. For example, various mobile communication device form factors have been developed such as the candy bar form factor, the clam shell form factor, and the slider phone form factor, and are currently well known for their ease of use and stability

However, ergonomics and/or the facilitation of various new applications for communications devices continue to play an important role in form factor development. For example, television viewing or two-player gaming applications using existing communications device form factors may be inconvenient or impossible depending upon the application requirements or other factors such as the user's location.

Therefore, what is needed are new form factors that better facilitate various multi-media and/or other device application usage and viewing.

### BRIEF DESCRIPTION OF THE DRAWINGS

FIG. 1 depicts an embodiment of an electronic device and in particular, a mobile communication device having a twist form factor and in a closed position;

FIG. 2 depicts the electronic device 102 of FIG. 1 in an open configuration;

FIG. 3 depicts a device similar to that of FIG. 2 in a closed position;

FIG. 4 depicts an interior surface of a device similar to that of FIG. 2 including a keypad user interface;

FIG. 5 depicts an interior surface of a device similar to that of FIG. 2 including a control panel user interface; and

FIG. 6 illustrates a method for operating the described device.

### DETAILED DESCRIPTION

Disclosed is an electronic device including a first and second housing. Each housing may support one or more displays, and has a housing obverse, also referred to as a front face and a housing reverse, also referred to as a back face. Each housing may include one or more display screens that may be on the front face, the rear face or on both sides of the housing. A hinge may couple the first housing and the second housing. The hinge may be configured to allow the first housing and the second housing to change their orientation relative to one another with a twist motion, causing a rotation of one housing with respect to the other around an axis defined by the hinge. With a twist motion, the housings can form a plurality of open configurations and at least one closed configuration. For example, the housings may be rotated 360 degrees with respect to one another. Each of the housings may be of any suitable geometry such that together they form a shape such as, but not limited to, a square, a sphere, a rectangle, a triangle, two triangles, a disk or an oval, and configurable into a “closed” and “opened” orientations. In this way, a “twist phone” form factor may provide one or more shapes and operate in a manner that allows new and/or improved features and/or applications that may be desirable to a user.

In a closed orientation, the first housing obverse and the second housing obverse may abut to form contiguous surfaces. The disclosed electronic device may further include a controller coupled to, for example, a first display screen and to a second display screen and may be configured to provide multiple display screen modes based on an orientation of the plurality of orientations of the first housing relative to the second housing. In one embodiment in a closed orientation the first housing obverse and the second housing obverse are aligned. Accordingly, when they are in a closed position and where the first display screen forms a part of the first housing obverse and the second display screen forms a part of the second housing obverse, the first display screen and the second display screen may be configured in a first multiple display screen mode to display a continuous image across both the first display screen and the second display screen. Accordingly, a user would be able to view one image across both screens as if the two screens were one screen. Likewise, in another embodiment, the first housing reverse and second housing reverse may additionally house a third display screen and a fourth display screen, respectively, such that the contiguous surface of the housings in a closed orientation, aligns the third display screen and the fourth display screen and allows them to function as a single display in the closed, or “aligned” orientation.

In another embodiment, where the first housing and second housing are in an opened position so that the first housing obverse and the second housing obverse are not aligned, the display screens may display different images, or the same image on each screen, such images being dependent upon the display screens modes that may be based on orientation of the two housings with respect to one another. As mentioned above, the disclosed controller coupled to the first display screen and to the second display screen may be configured to provide multiple display screen modes based on an orientation of the plurality of orientations of the first housing relative to the second housing.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Some of the functionality related to the various embodiments disclosed herein may require software programs or instructions and integrated circuits (ICs) such as application specific ICs, and may require coordination with other various software programs or instructions operational within a mobile communication device for example, for displaying indicia or content on one or more displays operating in a manner corresponding to the position of the housings. It is expected that one of ordinary skill, when guided by the concepts and principles disclosed herein will be readily capable of generating such software instructions and programs and/or ICs with minimal experimentation. Therefore, in the interest of brevity and minimization of any risk of obscuring the principles and concepts according to the various embodiments herein disclosed, further discussion of such software and ICs, if any, will be limited to the essentials sufficient to facilitate understanding by one of ordinary skill.

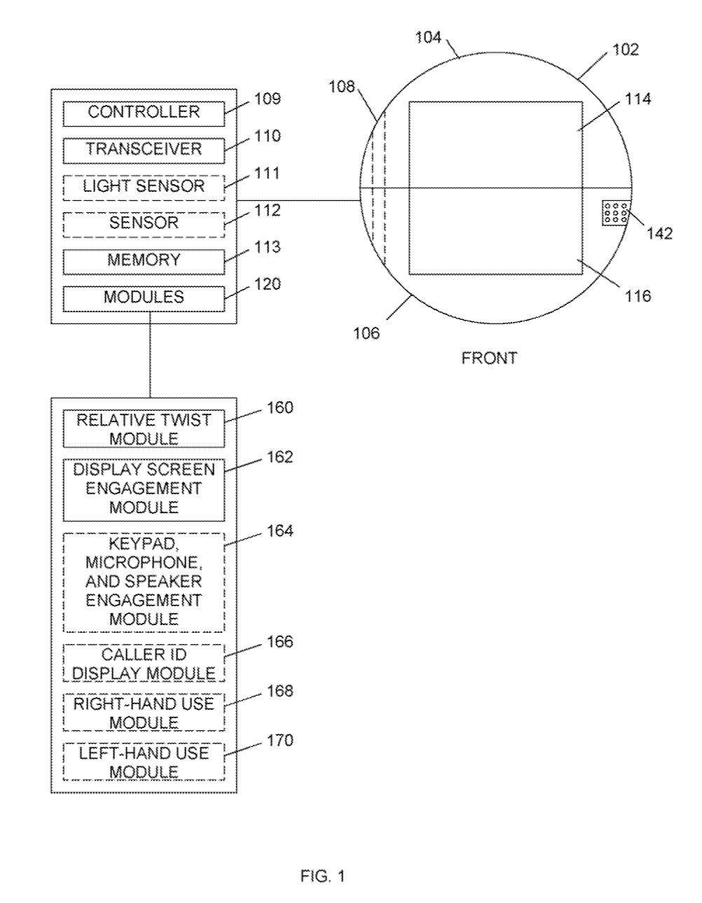

FIG. 1 depicts an embodiment of an electronic device and in particular, a mobile communication device having a twist form factor. The electronic device 102 depicted as a mobile communication device may be any type of mobile communication device. The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP), etc.

FIG. 1 depicts the front side of the device 102 having the shape of a disk, including a first housing portion 104 and a second housing portion 106, in this example, the housing portions being halves of the disk. The two housing portions may be coupled by a hinge 108. The first housing 104 and the second housing 106 may be coupled and configured to allow the first housing and the second housing to change their orientation relative to one another with a twist motion around an axis of the hinge 108. For example, the hinge 108 may be a pin hinge or any other suitable configuration such as the various rotational hinge configurations disclosed in U.S. Patent Application Publication No. 2005/0085273, App. Ser. No. 10/689,488 (published Apr. 21, 2005) [hereinafter “Patent App. Pub. 85273”] which is hereby incorporated by reference herein. The electronics of the device may be coupled through connections that are supported through the interior of the hinge 108, such as the flexible circuit routing described in Patent App. Pub. 85273. The electronics of the device can include a controller 109, a transceiver 110, a light sensor 111, a motion sensor or accelerometer 112, and a memory 113. A microphone 142 is also depicted on the second housing. In the various embodiments, each housing may have a microphone and earpiece speaker located such that the device 102 may be used in various configurations. Thereofore the device 102 may have two or more speakers and two or more microphones in some embodiments.

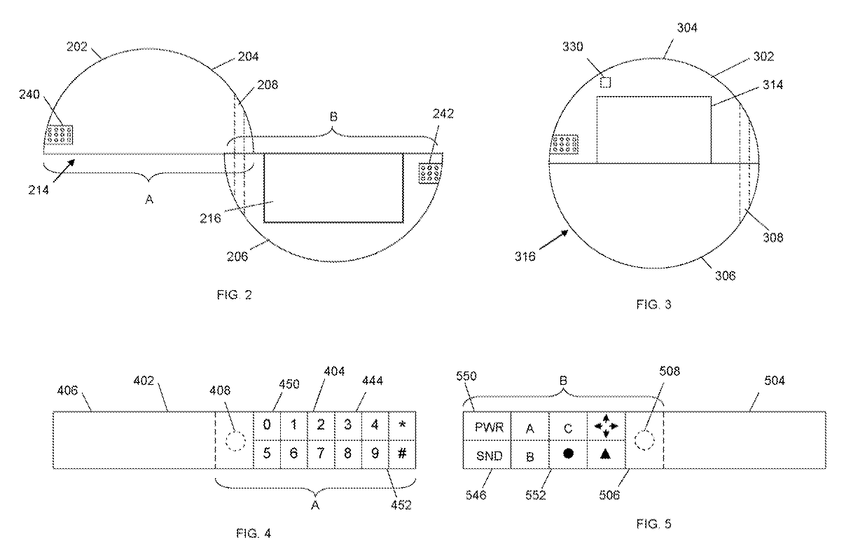

In FIG. 1, the first housing 104 and the second housing 106 are depicted as having a closed orientation so that the first housing obverse and the second housing obverse abut to form substantially contiguous surfaces. The first housing 104 is depicted as including a first display screen 114 and the second housing is depicted as including a second display screen 116. The first housing 114 and the second housing 116 may have at least one open orientation (see FIG. 2), the hinge 108 being configured to enable a plurality of orientations of the first housing relative to the second housing.

The controller 109 may be coupled to the first display screen 114 and to the second display screen 116 and may be configured to provide multiple display screen modes based on an orientation of the plurality of orientations of the first housing relative to the second housing. The modes may be processed by the controller in conjunction with modules 120. The modules 120 can include a relative twist module 160, a display screen engagement module 162, a keypad, microphone and speaker engagement module 164, a caller ID display module 166, a right-hand use module 168 and a left-hand use module 170, as will be described in more detail below.

The modules can carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

FIG. 2, as mentioned above, depicts the electronic device 102 (see FIG. 1) in an open configuration. The first housing 204 and the second housing 206 may have at least one open orientation. There may be a plurality of orientations that includes an open orientation with a relative angle of 180 degrees between the first housing obverse and the second housing obverse. Since FIG. 1 depicts an electronic device having two display screens, 114 and 116, that are each on a housing obverse, the front side of the housing, then when the device 202 is in an open configuration, one display screen 216 can be seen on the side of the device 202 facing out of the page as illustrated in FIG. 2. FIG. 2 depicts a full open orientation of the first housing 204 and the second housing 206. In one embodiment, the first display screen 214, which may be on the side of the device 202 facing into the page as illustrated in FIG. 2, and the second display screen 216 are configured in a second multiple display screen mode, for example, to display the same image when the first housing obverse and the second housing obverse are oriented with a relative angle of 180 degrees. In this embodiment, two users can view the same image from opposite side of the device.

The hinge 208 may be configured to enable a plurality of orientations of the first housing 204 relative to the second housing 206. Stopping points in the movement may provide preferred orientations. As previously mention, the controller 109 can be coupled to the first display screen 214 and to the second display screen 216 and configured to provide multiple display screen modes based on an orientation of the plurality of orientations of the first housing relative 204 to the second housing 206.

Returning to FIG. 1, the electronic device 102 is depicted with two display screens 114 and 116 that abut when the device 102 is in a closed position. In this way, the first display screen 114 and the second display screen 116 may be configured in a first multiple display screen mode to display a continuous image across both the first display screen 114 and the second display screen 116 when the first housing obverse and the second housing obverse are aligned. In one embodiment, the first housing 104 and the second housing 106 may be aligned and the first display screen 114 and the second display screen 116 are configured to display images that are stitched together to form a continuous image across the first display screen and the second display screen. Stitching the display images together may be performed by the controller 109 in response to instructions made available when the device 102 is in a closed orientation. In this way, the two small screens may behave together as one larger screen, providing a user with a fuller viewing experience.

FIG. 3 depicts a device 302 in a closed position. The first housing 304 may support a display screen 314 that is supported away from the edge of the housing 304. In FIG. 3, the second housing 306 may support a display screen on the housing reverse that is not shown in the figure. It is understood that any display screen configuration is within the scope of this discussion, including a device that has between one and four or more display screens in any suitable configuration. For example, in one embodiment, the first display screen 314 and/or the second display screen 316 may include a touch screen. In one embodiment, the second display screen 316 may be configured to display a touch screen menu of display options for the first display screen 314.

In the configuration shown in FIG. 3, when the first housing 304 and the second housing 306 change their orientation relative to one another with a twist motion around an axis of the hinge 308, so that the device is in one of a plurality of open configurations, the second display screen 316 may be visible to the viewer. As mentioned, a display screen may be of any type. For example, the display screen may provide caller ID. It is understood that a display screen need not be flush to the edge of its housing. In one embodiment, the device can include a sensor 330 configured to provide data to the controller 109 (see FIG. 1) indicating whether the first display screen 314 is facing upward. The controller may be configured to provide caller identification information to the first display screen 314 when the controller 109 receives data from the sensor 330 indicating that the first display screen 314 is facing upward. In another example, the caller ID may be indicated on any display when that display is facing upward. In this way, the controller 109 may be configured to provide multiple display screen modes based on an orientation of one or more of the housings 304 and/or 306. In one embodiment, the sensor 330 may be an accelerometer or another motion sensor 112 (see FIG. 1). In another embodiment, the sensor 330 may be a light sensor 111 to detect, for example, whether the device is laid down, for example, on a table so that the controller can process a display screen mode where the display screen is not illuminated for power savings. Depending on the open and/or closed configuration of the device, one or more display screens may be in an off mode.

In another embodiment, the controller 109 may be configured to provide a display screen mode based on an orientation of the plurality of orientations of the first housing relative to the second housing so that in one orientation the controller 109 may execute instructions for answering a voice call and in another orientation, the controller 109 may execute instructions for answering a multimedia call. It is understood that different orientations of the housings with respect to one another and in cooperation with the different display configurations may provide different suitable modes of operation of the display screens.

The shape of the device 102 is depicted in FIG. 1 as a disk. However, it is understood that each of the housings, the first housing 104 and the second housing 106 can have any suitable shapes. In this example, the microphone and speakers may be placed at locations so that when the device is in an open orientation as shown in FIG. 2, the speaker 240 and microphone 242 are distal to one another. In private use mode, the microphone 242 may be positioned close to a user's mouth and the speaker 240 may be positioned close to a user's ear.

In one embodiment, the speaker 240 may be coupled to the controller 109 (see FIG. 1) and supported by the first housing 204 and the microphone 242 may be coupled to the controller 109 and supported by the second housing 206. Symmetry may be advantageous for right-hand use of the device 202 and for left-hand use of the device 202 in the open configuration. In that case, a microphone shutter may be utilized with the microphone 242 and a speaker shutter may be utilized with the speaker 240. In such an embodiment, a microphone shutter may be configured to expose the microphone 242 for right-hand use of the device 202 when the twist motion is clockwise, and configured to expose the microphone 242 for left-hand use of the device 202 when the twist motion is counterclockwise. Additionally, a speaker shutter may be configured to expose the speaker 240 for right-hand use of the device 202 when the twist motion is clockwise, and configured to expose the speaker 240 for left-hand use of the device 202 when the twist motion is counterclockwise.

In another embodiment, for symmetry, there may be two microphones and two speakers. The second microphone and the second speaker, for example, may be positioned opposite their first counterparts. In such an embodiment, the controller 109 (see FIG. 1) may be configured to enable the first microphone 242 and disable the second microphone with for example a shutter, or via electronic switching, or by a combination thereof, for right-hand use of the device when the twist motion is clockwise, and configured to enable the second microphone and disable the first microphone 242, for left-hand use of the device when the twist motion is counterclockwise. Additionally, the controller may be configured to enable the first speaker 240 and disable the second speaker with for example, a shutter, or via electronic switching, or by a combination thereof, for right-hand use of the device when the twist motion is clockwise, and configured to enable the second speaker and disable the first speaker 240, for left-hand use of the device 202 when the twist motion is counterclockwise.

In another embodiment, the controller 109 (see FIG. 1) may be configured to provide a multimedia mode in which separation of the two microphones in the open orientation may automatically enable stereo audio recording. In addition, the controller 109 may be configured so that separation of the two speakers in the open orientation may automatically enable stereo playback. Stereo microphones and recording, and stereo speakers and playback, may become increasingly important for mobile devices. It is understood that a multimedia mode as just described may be included in any multiple display screen mode.

In another embodiment, the controller 109 (see FIG. 1) may execute instructions for right hand use of the device and instructions for left hand use of the device. For example, device 102 may be configured to provide multiple display screen modes based on whether the twist motion used to place the device in an open orientation is a clockwise twist motion or a counterclockwise twist motion. The direction of the twist motion and/or the closed or variety of open orientations may provide a plurality of different situations that may initiate different sets of instructions for processing by the controller 109.

Again referring to FIG. 2, the device 202 is depicted in an open orientation. The device 202 may have locations available for other types of user interfaces, such a keypad. For example, interior surfaces A and B may be utilized for different types of user interfaces. In one embodiment shown by FIGS. 4 and 5 the interior surfaces of the device may include user interfaces.

FIG. 4 depicts interior surface A including a keypad 444. FIG. 4 further illustrates the first housing 404 including housing obverse 450 and housing reverse 452, and hinge 408 that may couple the first housing 404 to the second housing 406. It is understood that the keypad user interface may be positioned in any suitable location. In the case of a device 402 having the shape of a disk, it may be advantageous to use the interior flat surface for the keypad type user interface. In a device 402 having a different shape, another surface may be more advantageous to use. It is understood that the device 402 may have any suitable shape.

FIG. 5 depicts interior surface B including a control panel 546. FIG. 5 further illustrates the second housing 506 including housing obverse 550 and housing reverse 552, and hinge 508 that may couple the first housing 504 to the second housing 506. It is understood that the control panel user interface may be positioned in any suitable location, for example, depending upon the shape of the device.

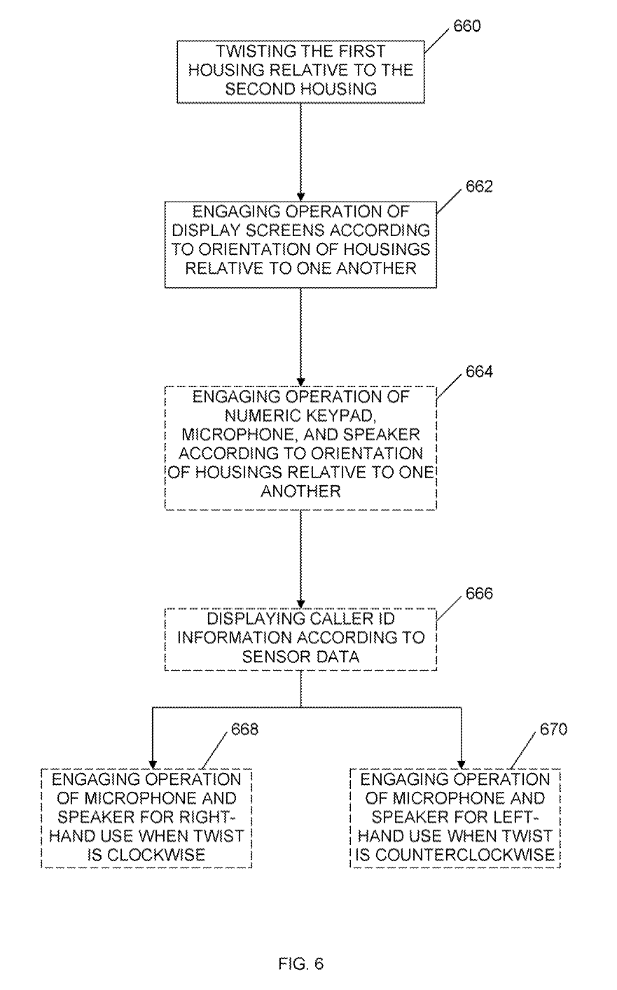

FIG. 6 illustrates a method for operating a device in accordance with various embodiments as described above. The method may include twisting the first housing relative to the second housing 660 as to change their orientation relative to one another while pivoting on the hinge, the first housing and the second housing having a closed orientation prior to twisting in which the first housing obverse and the second housing obverse abut to form contiguous surfaces, and having an open orientation after twisting. The twisting step may be executed in accordance with a relative twist module 160 (see FIG. 1) to determine the orientation of the device upon twisting. In another step, the method may include engaging operation of the first display screen and the second display screen 662 according to an orientation of the first housing relative to the second housing after the orientation of the housings relative to one another has been changed. The engagement step may be executed in accordance with a display screen engagement module 162.

An embodiment of a method of the described device may include any number of steps. For example, the method may include engaging operation of the numeric keypad, the microphone, and/or the speaker after the orientation of the housings relative to one another has been changed 664 in accordance with the keypad, microphone and speaker engagement module 164 (see FIG. 1). In another example, the method may include displaying caller identification information on the first display screen or on the second display screen according to the sensor data 666 in accordance with the caller ID display module 166. In another example, the method can include engaging operation of the microphone for right-hand use of the device when the twist motion is clockwise 668 and/or engaging operation of the microphone for left-hand use of the device when the twist motion is counterclockwise 670. In another example, the method can include engaging operation of the speaker for right-hand use of the device when the twist motion is clockwise and/or engaging operation of the speaker for left-hand use of the device when the twist motion is counterclockwise. The right-hand use module 168 and the left-hand use module 170 may provide instructions for steps 668 and/or 670 as well as other types of instructions based on the direction of the twisting motion of the device.

The disclosed improved and/or new twist phone form factor may provide a device capable of a twist motion so that the housings can form an open configuration and a closed configuration. The disclosed electronic device may further include a controller coupled to the first display screen and to the second display screen and configured to provide multiple display screen modes based on an orientation of the plurality of orientations of the first housing relative to the second housing. The display screens may display different images, or the same image on each screen, such images being dependent upon the display screens modes that may be based on orientation of the two housings with respect to one another. As mentioned above, the disclosed controller coupled to the first display screen and to the second display screen may be configured to provide multiple display screen modes based on an orientation of the plurality of orientations of the first housing relative to the second housing. In this manner, two screens may show a single image to provide a larger image when the device is in a closed position, and/or two screens may show the same image when the device is in the open position so that two users may view the same image from different viewing positions. The disclosed improved and/or new form factors may therefore enable additional and/or improved features while maintaining or decreasing the size of a device while taking account ergonomic considerations while providing a manner in which a manufacture may be distinguished from other manufacturers.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. An electronic device, comprising:
a first housing supporting a first display screen and having a first housing obverse;
a second housing supporting a second display screen and having a second housing obverse; and
a hinge coupled to the first housing and to the second housing and configured to allow the first housing and the second housing to change their orientation relative to one another with a twist motion around an axis, the first housing and the second housing having a closed orientation in which the first housing obverse and the second housing obverse abut to form contiguous surfaces, and the first housing and the second housing having at least one open orientation, the hinge configured to enable a plurality of orientations of the first housing relative to the second housing.

2. The electronic device of claim 1, further comprising:
a controller coupled to the first display screen and to the second display screen and configured to provide multiple display screen modes based on an orientation of the plurality of orientations of the first housing relative to the second housing.

3. The device of claim 1, wherein:
the first display screen forms a part of the first housing obverse;
a second display screen forms a part of the second housing obverse;
the first display screen and the second display screen are configured in a first multiple display screen mode to display a continuous image across both the first display screen and the second display screen when the first housing obverse and the second housing obverse are aligned.

4. The device of claim 3, wherein:
the plurality of orientations further includes an open orientation with a relative angle of 180 degrees between the first housing obverse and the second housing obverse; and
the first display screen and the second display screen are configured in a second multiple display screen mode to display the same image when the first housing obverse and the second housing obverse are oriented with a relative angle of 180 degrees.

5. The device of claim 3, wherein the first display screen or the second display screen includes a touch screen.

6. The device of claim 1, further including:
a sensor configured to provide data to the controller indicating whether the first display screen is facing upward;
wherein the controller is configured to provide caller identification information to the first display screen when the controller receives data from the sensor indicating that the first display screen is facing upward.

7. The device of claim 6, wherein the sensor is an accelerometer.

8. The device of claim 1, further comprising:
a numeric keypad coupled to the controller and supported on a surface of the first housing, the surface interior to the electronic device when the first housing and the second housing have the closed orientation;
a microphone coupled to the controller and supported by the first housing; and
a speaker coupled to the controller and supported by the second housing;
wherein the keypad, microphone, and speaker are configured to be operable when the device has an open orientation between the first housing obverse and the second housing obverse.

9. The device of claim 8, further comprising:
a microphone shutter configured to expose the microphone for right-hand use of the device when the twist motion is clockwise, and configured to expose the microphone for left-hand use of the device when the twist motion is counterclockwise; and
a speaker shutter configured to expose the speaker for right-hand use of the device when the twist motion is clockwise, and configured to expose the speaker for left-hand use of the device when the twist motion is counterclockwise.

10. The device of claim 8, wherein the microphone is a first microphone and the speaker is a first speaker, the device further comprising:
a second microphone; and
a second speaker;
wherein:
the controller is configured to enable the first microphone and disable the second microphone, for right-hand use of the device when the twist motion is clockwise, and configured to enable the second microphone and disable the first microphone, for left-hand use of the device when the twist motion is counterclockwise; and
the controller is configured to enable the first speaker and disable the second speaker, for right-hand use of the device when the twist motion is clockwise, and configured to enable the second speaker and disable the first speaker, for left-hand use of the device when the twist motion is counterclockwise.

11. The device of claim 1, wherein:
the first housing has a first housing reverse opposite the first housing obverse, the first display screen forming a part of the first housing reverse;
wherein:
the first housing and the second housing have an open orientation with a relative angle of 180 degrees between them;
the first display screen is configured to display an image; and
the second display screen is configured to display a touch screen menu of display options for the first display screen.

12. An electronic device, comprising:
a first housing having a first housing obverse;
a second housing having a second housing obverse;
a first display screen supported by the first housing and forming a part of the first housing obverse;
a second display screen supported by the second housing and forming a part of the second housing obverse; and
a hinge coupled to the first housing and to the second housing and configured to allow the first housing and the second housing to change their orientation relative to one another with a twist motion around an axis, the first housing and the second housing having a closed orientation in which the first housing obverse and the second housing obverse abut to form contiguous surfaces, and the first housing and the second housing having at least one open orientation, the hinge configured to enable a plurality of orientations of the first housing relative to the second housing, wherein the plurality of orientations includes an orientation in which the first face and the second face are aligned and the first display screen and the second display screen are configured to display images that are stitched together to form a continuous image across the first display screen and the second display screen.

13. The electronic device of claim 12, further comprising:
a controller coupled to the first display screen and to the second display screen and configured to provide multiple display screen modes based on an orientation of the plurality of orientations of the first housing relative to the second housing.

14. The device of claim 12, wherein the first housing further has a first housing reverse, the device further comprising:
a third display screen supported by the first housing and forming a part of the first housing reverse.

15. The device of claim 14, further comprising:
an accelerometer configured to provide data to the controller indicating whether the first display screen is facing upward;
wherein the controller is configured to provide caller identification information to the first display screen when the controller receives data from the accelerometer indicating that the first display screen is facing upward, and configured to provide caller identification information to the third display screen when the controller receives data from the accelerometer indicating that the third display screen is facing upward.

16. The device of claim 12, further comprising:
a memory configured to store instructions for answering a voice call and instructions for answering a multimedia call;
wherein the controller is configured to execute the instructions for answering a voice call and to execute the instructions for answering a multimedia call.

17. The device of claim 16, wherein:
the memory is further configured to store instructions for right hand use of the device and instructions for left hand use of the device; and
the controller is further configured to execute the instructions for right hand use of the device and to execute the instructions for left hand use of the device.

18. The device of claim 12, wherein the controller is further configured to provide multiple display screen modes based on whether the twist motion used to place the device in an open orientation is a clockwise twist motion or a counterclockwise twist motion.

19. A method in an electronic device comprising a first housing supporting a first display screen and including a first housing obverse, a second housing supporting a second display screen and including a second housing obverse, and a hinge coupled to the first housing and to the second housing, the method comprising:
twisting the first housing relative to the second housing so as to change their orientation relative to one another while pivoting on the hinge, the first housing and the second housing having a closed orientation prior to twisting in which the first housing obverse and the second housing obverse abut to form contiguous surfaces, and having an open orientation after twisting;
engaging operation of the first display screen and the second display screen according to an orientation of the first housing relative to the second housing after the orientation of the housings relative to one another has been changed.

20. The method of claim 19, the device further comprising a numeric keypad, a microphone, and a speaker, and configured as a mobile communication device, the method further comprising:
engaging operation of the numeric keypad, the microphone, and the speaker after the orientation of the housings relative to one another has been changed.

21. The method of claim 20, the device further comprising a sensor configured to provide sensor data, the method further comprising:
displaying caller identification information on the first display screen or on the second display screen according to the sensor data.

22. The method of claim 20, wherein the twisting comprises a twist motion, the method further comprising:
engaging operation of the microphone for right-hand use of the device when the twist motion is clockwise;
engaging operation of the microphone for left-hand use of the device when the twist motion is counterclockwise;
engaging operation of the speaker for right-hand use of the device when the twist motion is clockwise; and
engaging operation of the speaker for left-hand use of the device when the twist motion is counterclockwise.
